(19) United States
(12) Patent Application Publication
(10) Pub. No.: US 2011/0204574 A1
(43) Pub. Date: Aug. 25, 2011

(54) SLIDE RING SEAL

(76) Inventor: Mathias Grünaug, Kissing (DE)

(21) Appl. No.: 13/057,815

(22) PCT Filed: Jul. 16, 2009
(86) PCT No.: PCT/DE2009/000992

§ 371 Date: Feb. 7, 2011

(30) Foreign Application Priority Data
Aug. 6, 2008 (DE) 10 2008 036 489.4

(51) Int. Cl. F16J 15/34

(52) U.S. Cl. 277/358

(57) ABSTRACT

A slide ring seal, particularly a running gear seal, comprising at least one slide ring having an angular cross-section, the radial limb of which has a running surface and the axial limb of which is provided to receive an elastomer spring element, wherein the slide ring can be introduced into an associated seal holder in the operating state and the spring element is provided with at least one constriction to form sealing and spring regions, said constriction extending at least over the lengths of the axial and radial limbs, and wherein the sealing and spring region of the spring element provided on the running surface side fits over at least part of the wall thickness of the radial limb.

The invention concerns a bearing ring seal, in particular a drive seal.

Conventional drive seals with conical seal rings and round seal rings have the problem that shifting of the round seal ring can occur if certain environmental media (coal, concrete or the like) penetrate the sealing area. This shifting leads to impaired functionality of the drive seal in many cases.

DE 199 55 859 A1 refers to a bearing ring seal, in particular a drive seal, consisting of a bearing and/or counter ring, in an associated fixture area, which is equipped with a specific conical peripheral surface outside its sliding surface for fitting at least one resilient rolling element. The bearing and/or counter ring has an additional reinforcing sealing element, which is operatively connected, at least in assembly condition. This sealing element has a multiple flute design. At least one thickened area is provided for between the individual sealing lips, which is fixed in such a way, in the fixture area in the bearing and/or counter ring assembly condition, that a least one of the sealing lips is pressed under tension onto a corresponding opposite surface of the fixture area of the bearing and/or counter ring.

Dirt can penetrate the sealing area through this additional sealing element, which has consequences. However, owing to the multiple-part design (rolling element, sealing element) used here; the technology is such that handling appears to be impractical and also increases costs.

The objective of the subject of the invention is to add to the design of the described bearing ring seal, so that it can dispense with the separate sealing element without dirt being able to penetrate the sealing area.

This objective is reached by means of a bearing ring seal, in particular a drive seal, comprising at least one seal ring that has an angular cross-section with a radial journal that has a running surface and with an axial journal intended for fitting an elastomer spring element. The seal ring in operating condition can be inserted into an associated sealing fixture and the spring element is equipped with a least one neck under the formation of the sealing and spring areas, which extend over at least the length of the axial and radial journals and with a sealing and spring area of the spring element on the running surface side that overlaps at least a part of the radial journal wall thickness.

Further beneficial developments of the bearing ring seal that is the subject of the invention are given in the associated sub-claims.

The shaped rubber part of the spring element that is the subject of the invention closes the gap between the sealing fixture and the seal ring inserted into it as a result of that shape thus effectively preventing the penetration of the environmental media. This ensures that impaired functionality of the drive seal is safely prevented.

The fact that current series production is not affected by changing the spring element that is the subject of the invention, as described in DE 199 55 859 A1, is beneficial, since the customer can continue to use the existing sealing fixtures and seal rings.

This measure not only prevents the penetration of dirt, but also stops the spring element from shifting. This means that longer sealing times can be achieved.

The subject of the invention is presented in a design example in the drawing and is described as follows. The drawings show:

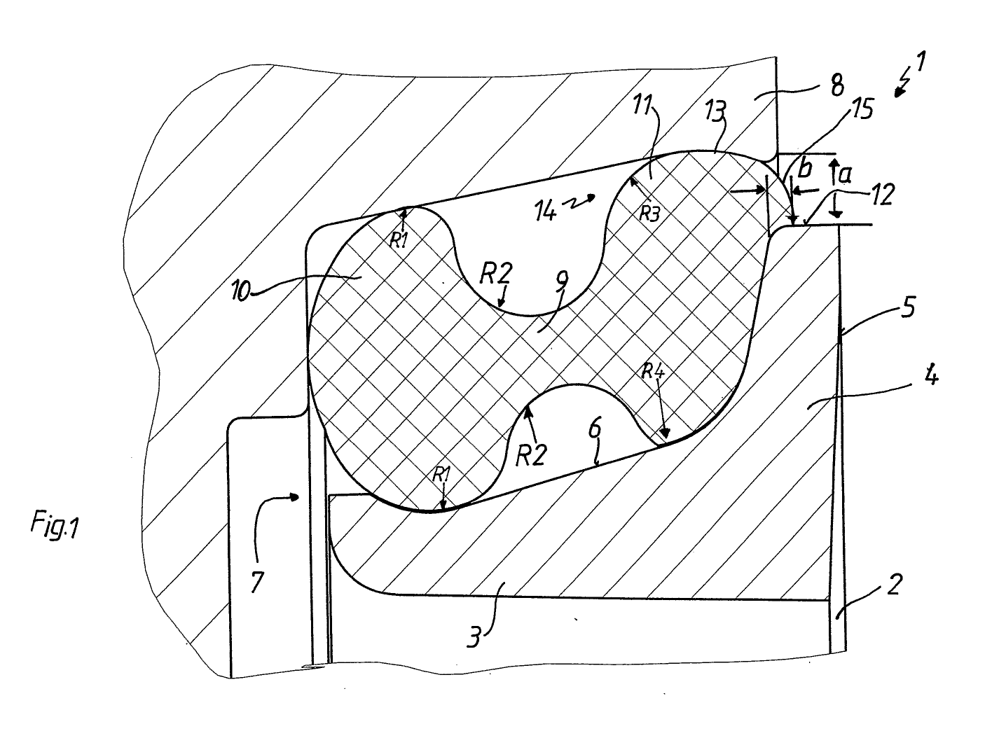

FIG. 1 Schematic diagram of a drive seal arranged in a sealing fixture;

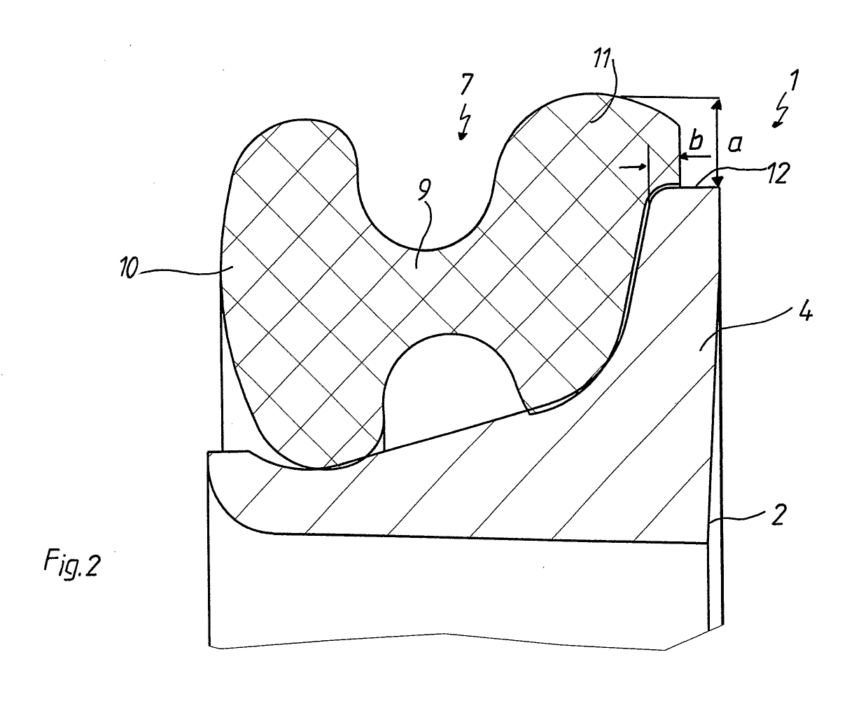

FIG. 2 Drive seal pursuant FIG. 1 as an individual part;

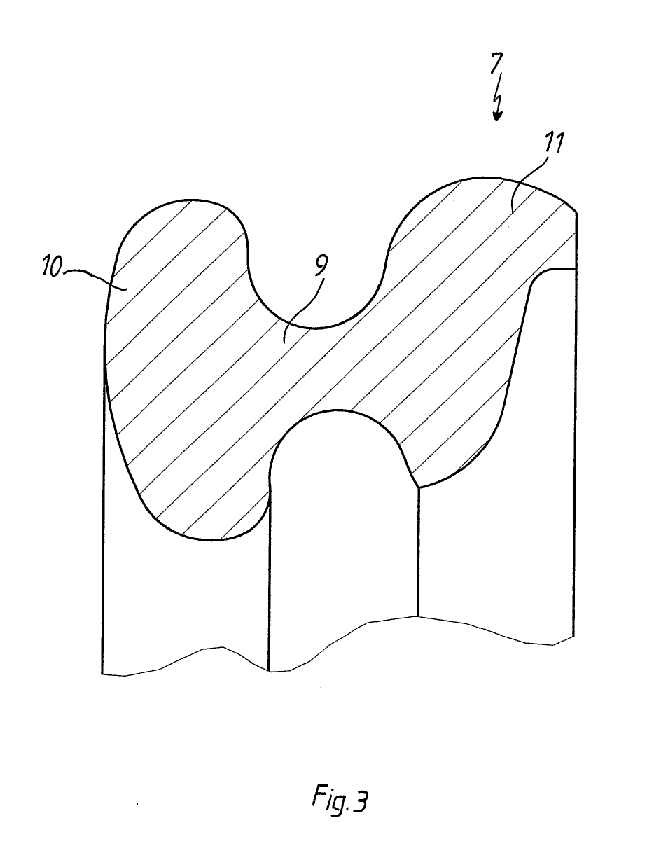

FIG. 3 Rubber-shaped part of the drive seal pursuant to FIG. 2.

FIG. 1 as a schematic diagram shows a bearing ring seal 1 in the form of a drive seal, comprising an angularly formed seal ring 2, which has an axial journal 3 and a radial journal 4. A running surface 5 extending above a specific radial height is provided for on radial journal 4. The axial journal 3 has a conically running fixture area 6 for an elastomer spring element 7. The drive seal 1 shown is illustrated in the assembly condition. The reference 8 leads to the sealing fixture. The spring element 7 that is the subject of the invention is equipped with a neck 9 (bridge), so that spaced sealing and spring areas 10 and 11 are formed. The neck 9 has only a small cross-section when compared with the sealing and spring areas 10 and 11. Radii R1, R2, R3 and R4, which merge into each other, extend from the inside and outside peripheral surfaces of each sealing and spring area 10 and 11, in the direction of the neck area 9 formed by the bridge. The sealing and spring area 11 is designed, in terms of its shape, so that it can follow the contour of the radial journal 4. The sealing and spring area 11 stands with the value “a” in front of the free end 12 of the radial journal 4 and overlaps a part b of the wall thickness of radial journal 4. Owing to this specially shaped design a section 13 of the sealing and spring area 11 provided for the running surface is touching a corresponding opposite surface 14 of the sealing fixture 8. The wall thickness of part b of section 15 of the sealing and spring area 11 overlapping the radial journal 4 now prevents environmental media from entering the spring element 7 area, and thus from entering the sealing area.

FIG. 2 shows the drive seal 1 as an individual part according to FIG. 1. The same references apply. The spring element 7, with the exception of a defined radial force component, which it underwent in the fixture area 6 of seal ring 2, is stress-free to the greatest possible extent. The neck 9 and the sealing and spring areas 10, 11 are recognizable. The distortion of the spring element 7 that is visible in FIG. 1, which has been created in the area of the sealing fixture 8 by the insertion of the drive seal 1, has not yet appeared here. That the sealing and spring area 11 with the value a projects over the free end 12 of the radial journal 4 and overlaps a part b of the wall thickness of radial journal 4, can also be seen here.

FIG. 3 shows the drive seal 7 as an individual part pursuant to FIG. 2. The same references also apply here. It can be seen that the sealing and spring areas 10 and 11 have geometrically different shapes, which has nothing to do with the illustrated seal ring. The neck 9 is arranged as a crosspiece connection between the sealing and spring areas 10 and 11.

1. A bearing ring seal, comprising at least one seal ring that has an angular cross-section with a radial journal that has a running surface and with an axial journal adapted for fitting an elastomer spring element wherein the seal ring in operating condition can be inserted into an associated sealing fixture and the spring element is equipped with a least one neck under the formation of the sealing and spring areas, which extend over at least the length of the axial and radial journals and with a sealing and spring area of the spring clement on the running surface side that overlaps at least a part of the radial journal wall thickness.

2. A bearing ring seal pursuant to claim 1, wherein the neck is designed to extend over approximately half the height of the spring element.

3. A bearing ring seal pursuant to claim 1, wherein the sealing and spring area of the spring element on the running surface side largely follows the back contour of the journal containing the running surface.

4. A bearing ring seal pursuant to claim wherein 1 the sealing and spring area on the running surface designed with a defined radial extension over which the radial journal with running surface extends.

5. A bearing ring seal pursuant to claim 1, wherein the spring element is formed by a shaped rubber part.

6. A bearing ring seal pursuant to claim 1, wherein the neck is produced by radii (R1 to R4) merging into each other; these radii start from the inside and outside diameters of the sealing and spring areas.
